(19) United States
(12) Patent Application Publication
(10) Pub. No.: US 2025/0096889 A1
(43) Pub. Date: Mar. 20, 2025

(54) COMMUNICATION ROUTE SETTING METHOD

(71) Applicant: NEC Corporation, Minato- ku, Tokyo (JP)

(72) Inventors: Jun KODAMA, Tokyo (JP); Yoshiaki SAKAE, Tokyo (JP); Hiroki TAGATO, Tokyo (JP); Takashi KONASHI, Tokyo (JP); Jun NISHIOKA, Tokyo (JP); Yuji KOBAYASHI, Tokyo (JP); Etsuko ICHIHARA, Tokyo (JP)

(73) Assignee: NEC Corporation, Minato- ku, Tokyo (JP)

(21) Appl. No.: 18/727,379

(22) PCT Filed: Jan. 26, 2022
(86) PCT No.: PCT/JP2022/002919

§ 371 Date: Jul. 9, 2024

(51) Int. Cl. H04B 10/077; H04L 45/02

(52) U.S. Cl. CPC H04B 10/0775; H04L 45/02

(57) ABSTRACT

A communication route setting device 100 of the present invention includes an optical signal acquisition unit 121 that acquires an optical signal on a transmission path in a network in which optical communication devices are connected to each other via an optical transmission path, a condition determination unit 122 that determines a physical condition of at least one object of the optical transmission path and the optical communication devices on the basis of the optical signal, and a route setting unit 123 that sets a communication route for transmitting the optical signal on the network on the basis of the determined physical condition.

### TECHNICAL FIELD

The present invention relates to a communication route setting method, a communication route setting device, and a program.

### BACKGROUND ART

In an optical transmission network in which optical transmission paths and optical communication devices are connected in a mesh state, a communication route is set in consideration of quality of service (QOS). In particular, since the amount of traffic flowing through the networks increases due to spread of the Internet, network congestion and delay become major problems recently. In order to prevent such problems, a communication route is set under band control, priority control, and the like.

Patent Literature 1 describes art in which machine learning is performed by using traffic information and congestion information of a network (NW) path, an alternate path predicted to have “no congestion” is calculated, and route design is performed with respect to routers. Specifically, in Patent Literature 1, a machine-learning device is provided between routers, and machine learning is performed by the machine-learning device based on the traffic information and the congestion information of the NW path between routers installed on the transmission path, and a learning model for performing predictive estimation of whether or not congestion will occur on the object NW path is constructed. Then, with use of the constructed model, the possibility of congestion on the route is predicted on the basis of the information acquired from each NW path in real time, which enables setting of a route bypassing the NW path having a high possibility of congestion.

### CITATION LIST

### Patent Literature

Patent Literature 1: WO 2019/026684 A

### SUMMARY OF INVENTION

### Technical Problem

However, in the art described in patent Literature 1, traffic information of a transmission path and past congestion information are used as data to be used for learning in the machine-learning device, and physical conditions at the location of the hardware including transmission paths and routers, such as natural environment and deterioration states of the devices, are not taken into account. Therefore, it is impossible to perform path design in consideration of changes in the natural environment such as icing and typhoon and conditions such as physical deterioration in the transmission paths. This causes a problem that when a failure or degradation in the transmission quality occurs due to a change in the natural environment or deterioration, it is impossible to reflect such a condition in the path design, so that it is impossible to set an appropriate communication route.

Therefore, an object of the present invention is to provide a communication route setting method that can solve the problem described above, that is, a problem that it is impossible to set an appropriate communication route.

### Solution to Problem

A communication route setting method, according to one aspect of the present invention, is configured to include
acquiring an optical signal on a transmission path in a network in which optical communication devices are connected to each other via an optical transmission path;
determining a physical condition of at least one object of the optical transmission path and the optical communication devices, on the basis of the optical signal; and
setting a communication route for transmitting the optical signal on the network, on the basis of the determined physical condition.

A communication route setting device, according to one aspect of the present invention, is configured to include
an optical signal acquisition unit that acquires an optical signal on a transmission path in a network in which optical communication devices are connected to each other via an optical transmission path;
a condition determination unit that determines a physical condition of at least one object of the optical transmission path and the optical communication devices, on the basis of the optical signal; and
a route setting unit that sets a communication route for transmitting the optical signal on the network, on the basis of the determined physical condition.

A program, according to one aspect of the present invention, is configured to cause a computer to execute processing to
acquire an optical signal on a transmission path in a network in which optical communication devices are connected to each other via an optical transmission path;
determine a physical condition of at least one object of the optical transmission path and the optical communication devices, on the basis of the optical signal; and
set a communication route for transmitting the optical signal on the network, on the basis of the determined physical condition.

### Advantageous Effects of Invention

With the configurations described above, the present invention can set an appropriate communication route while considering physical conditions of optical transmission paths and communication devices.

### BRIEF DESCRIPTION OF DRAWINGS

FIG. 1 is a schematic diagram illustrating the entire configuration of a network system according to a first example embodiment of the present invention.

FIG. 2 is a block diagram illustrating a configuration of the network management device disclosed in FIG. 1.

FIG. 3 is a flowchart illustrating a processing operation performed by the network management device disclosed in FIG. 1.

FIG. 4 is a flowchart illustrating a processing operation performed by the network management device disclosed in FIG. 1.

FIG. 5 illustrates a state of processing at the time of setting a communication route by the network management device disclosed in FIG. 1.

FIG. 6 illustrates a state of processing at the time of setting a communication route by the network management device disclosed in FIG. 1.

FIG. 7 illustrates a state of processing at the time of setting a communication route by the network management device disclosed in FIG. 1.

FIG. 8 illustrates a state of processing at the time of setting a communication route by the network management device disclosed in FIG. 1.

FIG. 9 is a block diagram illustrating a hardware configuration of a communication route setting device according to a second example embodiment of the present invention.

FIG. 10 is a block diagram illustrating a configuration of the communication route setting device according to the second example embodiment of the present invention.

FIG. 11 is a flowchart illustrating an operation of the communication route setting device according to the second example embodiment of the present invention.

### DESCRIPTION OF EMBODIMENTS

### First Example Embodiment

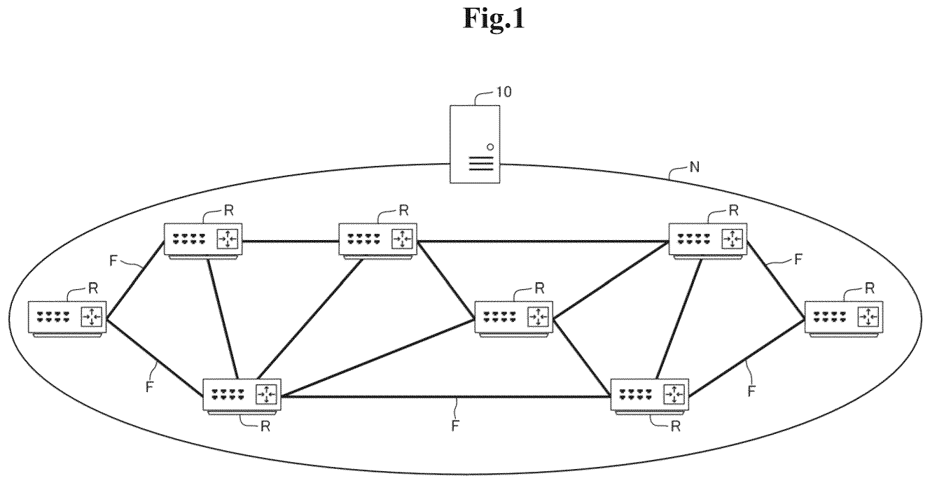

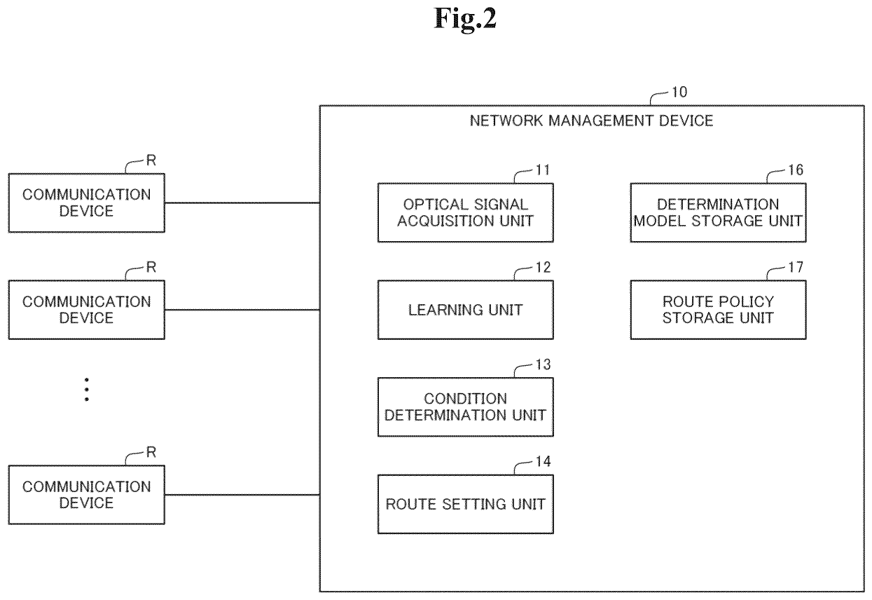

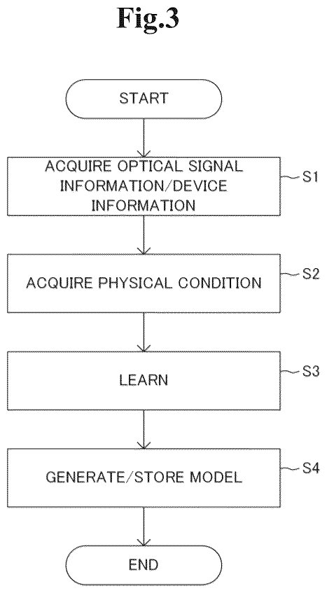

A first example embodiment of the present invention will be described with reference to FIGS. 1 to 8. FIGS. 1 and 2 are diagrams for explaining the configuration of a network system, and FIGS. 3 to 8 are diagrams for explaining the processing operation of the network system.

### [Configuration]

As illustrated in FIG. 1, a network system N of the present invention includes a plurality of communication devices R that are connected to each other via optical transmission paths F, and is formed in a mesh shape as a whole. The communication device R is configured of an optical communication device called optical transponder, and has a function of transferring an optical signal, received from an optical transmission path, to another optical transponder over a communication route based on the route information set. The optical transmission path F is formed of an optical fiber that transmits optical signals in which a plurality of frequencies are bundled, and is installed in various laying conditions such as in an exposed environment like a utility pole, in a bridge, and in a road pipe.

The network system N also includes a network management device 10 as illustrated in FIG. 1. The network management device 10 has a function of setting a communication route on the network by using a route policy, as described below. In particular, the network management device 10 of the present embodiment has a function of setting a communication route in consideration of the physical conditions of the optical transmission paths F and the communication devices R, in addition to the route policy.

Specifically, the network management device 10 is configured of one or a plurality of information processing devices each having an arithmetic device and a storage device, and is connected to all communication devices R. As illustrated in FIG. 2, the network management device 10 includes an optical signal acquisition unit 11, a learning unit 12, a condition determination unit 13, and a route setting unit 14. Each of the functions of the optical signal acquisition unit 11, the learning unit 12, the condition determination unit 13, and the route setting unit 14 can be implemented through execution, by the arithmetic device, of a program for implementing each function stored in the storage device. The network management device 10 also includes a determination model storage unit 16 and a route policy storage unit 17. Each of the determination model storage unit 16 and the route policy storage unit 17 is configured of a storage device. Hereinafter, the respective constituent elements will be described in detail.

The optical signal acquisition unit 11 acquires, from each communication device R, an optical signal communicated by the communication device R, and acquires optical signal information that is data representing the characteristics of such an optical signal. At that time, the optical signal information acquired by the optical signal acquisition unit 11 is data in which digital modulation signals are drawn on a complex plane, which is called a constellation, or data such as a polarized state indicating the state of the electric field at the time of radio wave transmission, which is called a state of polarization (SOP). However, the optical signal information acquired by the optical signal acquisition unit 11 is not limited to the information described above, and may be a signal representing any characteristics of the optical signal.

In addition to the optical signal information described above, the optical signal acquisition unit 11 also acquires device information representing conditions of devices including operation states such as loads of an optical transmission path and a communication device, temperature of the optical transmission path and the communication device, and ambient temperature that is surrounding temperature, from various sensors installed on the optical transmission path F or various sensors mounted on the communication device R. Note that the optical signal acquisition unit 11 may acquire any measurement values from any measurement devices on the network system as device information.

The optical signal acquisition unit 11 acquires and stores optical signal information such as a constellation or SOP described above at time intervals of one second for example, and records the time-series changes in the optical signal information, for example. The optical signal acquisition unit 11 also acquires and stores device information such as temperature and load at intervals of one second to several seconds, for example. However, the optical signal acquisition unit 11 may acquire the optical signal information and the device information at any time intervals or at any timing.

Note that the optical signal acquisition unit 11 may acquire the optical signal information and the device information as learning information for generating a determination model described below, or as a route setting information for setting a communication route of the optical signal. In the case of acquiring the optical signal information and the device information as learning information, the optical signal acquisition unit 11 previously acquires the optical signal information and the device information for a certain period and stores therein as learning data. In that case, the learning data includes training data to be used for learning, together with the learning data. The training data is data representing the external environmental conditions such as temperature and disaster at the installation location of the communication device R and the optical transmission path F, and deterioration states of the communication device and the optical transmission path, at the time when the learning data was acquired. As an example, the external environmental conditions include conditions such as weather conditions (rain, snow, wind, and the like) and disaster conditions (typhoon, fire, and the like) at the location where the communication device and the optical transmission path are installed and the neighborhood thereof. The deterioration states include conditions such as the number of years in use and failure state of the communication device and the optical transmission path. Accordingly, depending on the external environmental conditions and the deterioration states, the physical conditions of the communication device and the optical transmission path may be affected such as water leakage, icing, and wiring disconnection. Therefore, the external environmental conditions and the deterioration states can be said as physical conditions of the communication device and the optical transmission path.

The learning unit 12 (model generation unit) uses the learning information described above to generate a model representing the relationship between the route setting information acquired at the time of setting the communication route and the physical conditions of the communication device R and the optical transmission path F at that time, and stores it in the determination model storage unit 16. That is, the learning unit 12 uses the optical signal information and the device information such as a constellation and SOP acquired and stored by the optical signal acquisition unit 11 in advance, as learning data, and performs machine learning by using the external environmental conditions such as weather or disaster at the location where the communication device and the optical transmission path are installed at that time, and physical conditions that are deterioration conditions of the communication device and the optical transmission path, as training data, and generates a determination model configured to determine the external environmental conditions and the physical conditions such as deterioration states of the communication device and the optical transmission path, from optical signals and device information acquired later. At that time, the learning data does not necessarily include device information, and may include only optical signal information.

As an example, the learning unit 12 uses four types of information described below as learning data.

(From Constellation that is Optical Signal Information)
1. SN ratio indicating the amount of noise.
2. Attenuation information of a band affected by distortion and constriction of an optical fiber.

### (From Device Information)

3. Temperature of a communication device installed around an optical transmission path and ambient temperature.
4. Time for season information.

The learning unit 12 also uses the information described below as training data.

A. Physical Conditions of an Optical Fiber that is the Optical Transmission Path F (Icing, Rain, Lightning).

The learning unit 12 performs learning by using the information for learning as described above so as to be able to create a determination model as described below. For example, by learning optical signal information indicating that certain distortion of an optical fiber and specific noise components are included in winter, the learning unit 12 can create a determination model enabling estimation of icing on the optical fiber. As another example, in the case of raining, since vibration occurs intermittently on the optical fiber, vibration having a specific characteristic occurs in the constellation. Therefore, by learning the constellation representing such vibration, the learning unit 12 can create a model enabling estimation of a raining state. As another example, in the case of a heavy rain with lightning, an influence of lightning largely affects the polarization state. Therefore, by learning optical signal information in which large fluctuation of SOP and disturbance in the constellation occur, the learning unit 12 can also create a model enabling detection of lightning.

The condition determination unit 13 determines the physical conditions of the communication device R and the optical transmission path F on the basis of the optical signal information newly acquired at the time of setting the communication route of the optical signal. At that time, the condition determination unit 13 determines the physical conditions of the communication device R and the optical transmission path F from the acquired optical signal information, by using a determination model stored in the determination model storage unit 16. In particular, in the present embodiment, the condition determination unit 13 determines the physical conditions of the communication device R and the optical transmission path F by inputting the newly acquired optical signal information and device information to the determination model created as described above. However, the condition determination unit 13 may determine the physical conditions of the communication device R and the optical transmission path F by inputting only the optical signal information to the determination model.

Moreover, after performing estimation of the physical conditions, the condition determination unit 13 sets and outputs quality information representing the communication quality of a transmission path related to the communication device or the optical transmission path for which physical condition has been estimated, on the basis of the information of the estimated physical conditions, and the optical signal information such as acquired constellation and attenuation information of the signal band. For example, parameters of the quality information include four parameters, namely, availability quality, band quality, delay quality, and performance margin, each of which is set as a numerical value in ten levels from 1 to 10. It is set that as the number is larger, the quality is higher or performance margin is more sufficient.

As an example, when icing on the optical transmission path F is estimated as a physical condition and constriction (attenuation) of the signal band is largely attenuated from the expected signal band of the design level, the condition determination unit 13 sets a parameter of the band (width) quality to be lower as quality information, and outputs it. Moreover, when icing on the optical transmission path F is estimated as a physical condition and the SN ratio is low with high noise, the condition determination unit 13 sets a low parameter for the performance margin in which a change to a modulation mode having higher noise immunity although information compression rate is lower is assumed, and outputs it. As another example, when estimating sunny as a physical condition, on the contrary to the above case, the condition determination unit 13 sets the value of a parameter of the band quality/performance margin to be higher as quality information, and outputs it. Note that the condition determination unit 13 may set quality information from the estimated physical condition and the acquired optical signal information on the basis of the information representing the correspondence relationship between the physical conditions and optical signal information and the numerical values of the parameters of quality information in advance, or may set quality information from the estimated physical condition and the acquired optical signal information by using an arithmetic expression set in advance. Moreover, the condition determination unit 13 may calculate the quality information only from the estimated physical condition.

Note that the determination model may also be configured to output quality information. That is, the determination model may be created though learning by using the optical signal information and the device information as learning data, and using the physical condition and the quality information as training data. Moreover, the determination model may be configured to estimate a plurality of physical conditions, rather than estimating one physical condition, with respect to the communication device and the optical transmission path. In that case, the determination model may be configured to output estimation probability of each physical condition as well. As a result, the condition determination unit 13 may set quality information from the estimated physical conditions and the estimation probability thereof, and the acquired optical signal information.

The route setting unit 14 sets a communication route by performing matching on the route policy based on the QoS set by the user and stored in the route policy storage unit 17 and the quality information output from the condition determination unit 13. Specifically, the route policy stored in the route policy storage unit 17 is configured to output quality information parameters holding the QoS request with respect to four parameter that can be matched with the parameters of quality information output from the condition determination unit 13, and the route information calculated by means of a conventional technique. The route setting unit 14 calculates the degree of approximation between the quality information parameter stored in the route policy storage unit 17 and the quality information parameter output from the condition determination unit 13, and performs the closest matching, to thereby set the final communication route. Regarding the stored route policy, the route setting unit 14 performs preprocessing such as transformation into the same form as that of the quality information parameter output from the condition determination unit 13, and outputs the form on which matching can be performed. Since the quality information parameter output from the condition determination unit 13 is a value having been set based on the physical condition as described above, a communication route is set in consideration of the physical condition by the route setting unit 14.

In the route policy used for matching, the priority set by a user who uses the communication or an authorizer is received as an input, and a rule for performing route setting is set based on the input. For example, in the case where services of the communication quality that can be provided with respect to a QoS request include the following patterns:
1. Route enabling wide band transmission for providing large-amount video playback,
2. Routs capable of holding communication session with multiple devices such as IoT, and
3. Route enabling high reliability and low delay such as financial transaction, remote medical care, and inter-vehicle communication, by matching the communication quality service to be provided and the QoS request, the communication quality, corresponding to the service to be provided, is provided.

As described above, the route setting unit 14 compares the route policy with the quality information parameter output from the condition determination unit 13, and sets conditions for approximation and matching to each path, to thereby perform processing to determine the final end-to-end route. For matching between the route policy and the quality information parameter, machine learning or the like may be used besides the mathematical method of approximation or neighborhood search.

Note that the route setting unit 14 is not limited to set a communication route by using the quality information parameter as described above. The route setting unit 14 may set a communication route on the basis of the physical condition of the communication device R or the optical transmission path F that has been estimated simply. For example, the condition determination unit 14 may set a communication route by eliminating the communication device R or the optical transmission path F estimated to be in a particular physical condition such as icing or deterioration, or lowering the priority thereof.

### [Operation]

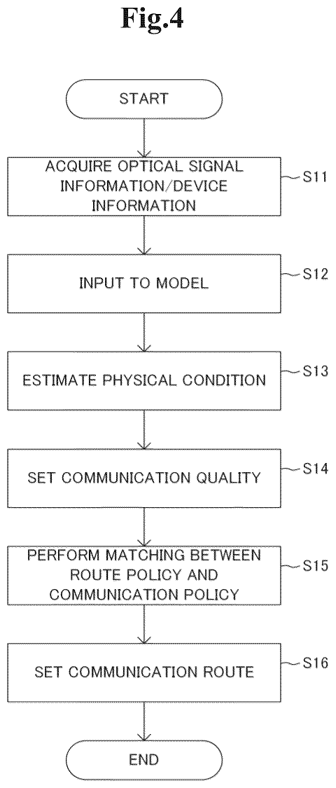

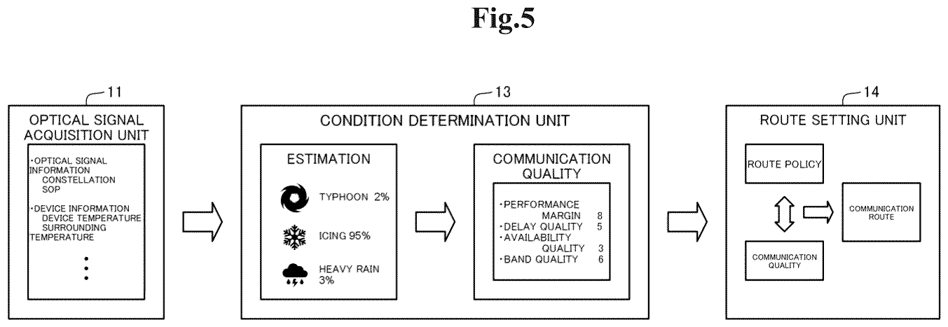

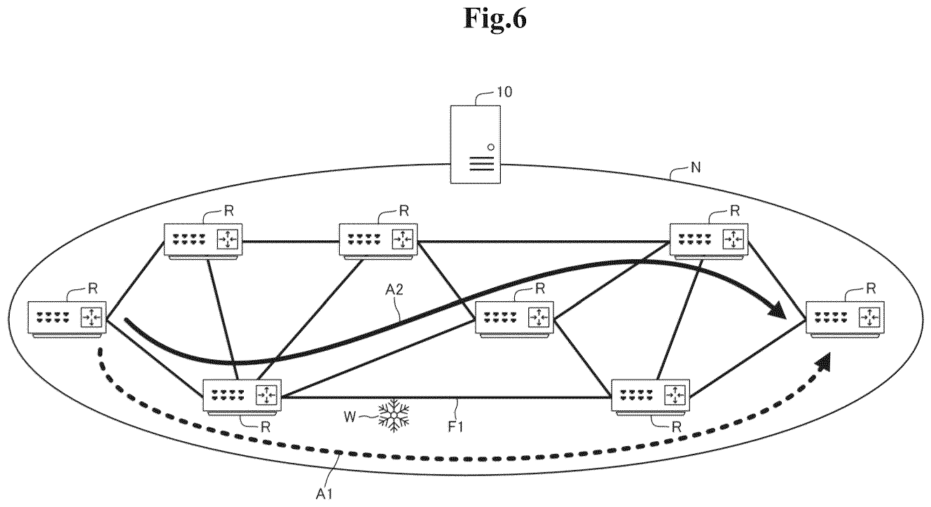

Next, a first example of operation of the network system N described above, in particular, the network management device 10, will be described with reference to the flowcharts of FIGS. 3 and 4, the operation outline diagram of FIG. 5, and the network diagram of FIG. 6. Note that operation of the network management device 10 is largely divided into a model creation phase and a route setting phase. First, a model creation phase will be described with reference to FIG. 3.

First, in the model creation phase, the optical signal acquisition unit 11 of the network management device 10 acquires, from each of the communication device R, an optical signal communicated by the communication device R, and acquires optical signal information such as a constellation and SOP from the optical signal (step S1). The optical signal acquisition unit 11 also acquires, from various types of sensors, device information including operating states such as loads on the optical transmission path and the communication device, temperature of the optical transmission path and the communication device, ambient temperature that is surrounding temperature, and the like (step S1). Then, the optical signal acquisition unit 11 stores the acquired information as learning data. Note that the optical signal acquisition unit 11 acquires both the optical signal information and the device information at time intervals of one second, and stores the acquired data.

Further, the network management device 10 acquires the external environmental condition such as weather or disaster at the location where the communication device and the optical transmission path are installed, and the deterioration states of the communication device and the optical transmission path, as training data, and stores them (step S2). In particular, in the first example, the external environmental condition is used as training data. Note that the training data is input by the administrator or the operator, or provided by another information processing device, whereby the data is acquired and stored by the network management device 10.

Thereafter, the learning unit 12 of the network management device 10 performs machine learning of the learning data and the training data (step S3), so as to generate a determination model for estimating the physical condition of the optical transmission path from the optical signal information and the device information (step S4). However, the learning may be performed by another information processing device other than the network management device 10. Then, the generated determination model is stored in the determination model storage unit 16 of the network management device 10 (step S4). In the first example, in particular, a model for estimating the external environmental condition that is weather at the location of the optical transmission path, for example, icing, heavy rain, or typhoon at the location of the optical transmission path, is generated.

Next, the route setting phase will be described with reference to FIGS. 4 to 6. In the route setting phase, an operation to set a communication route of an optical signal is performed when data transmission is made in the network system. Therefore, the network management device 10 has accepted a QoS request from a client (end user or network administrator) related to the data transmission, and has stored the route policy corresponding to the QoS request in the route policy storage unit 17, in advance. For example, the route policy is configured of four parameters of quality information and the route information corresponding thereto, as described above.

Then, at the time of performing data transmission, the optical signal acquisition unit 11 of the network management device 10 acquires, from each communication device R, a communicated optical signal, and acquires optical signal information such as a constellation and SOP from the optical signal. Moreover, the optical signal acquisition unit 11 acquires, from various types of sensors, device information including operating states such as loads on the optical transmission path and the communication device, temperature of the optical transmission path and the communication device, ambient temperature that is surrounding temperature, and the like (step S11).

Then, the condition determination unit 13 of the network management device 10 reads out a determination model stored in the determination model storage unit 16, and inputs the newly acquired optical signal information and device information to the determination model (step S12) to thereby estimate the physical conditions of the communication device R and the optical transmission path F (step S13). In the first example, as illustrated in FIG. 5, the external environmental condition such as “icing, heavy rain, or typhoon” is estimated, and the probability of each external environmental condition is also estimated. In particular, in this example, it is determined that the external environmental condition is “icing” among “icing, heavy rain, and typhoon”, and the probabilities of all estimated conditions are estimated as “icing 95%, heavy rain 3%, and typhoon 2%”.

Then, on the basis of the estimated condition and the probabilities as described above and the acquired optical signal information, the condition determination unit 13 calculates quality information parameters of the communication quality of the transmission path (step S14). For example, as illustrated in FIG. 5, four parameters, namely, availability quality, band quality, delay quality, and performance margin, are calculated as parameters of quality information. Note that calculation of the quality information parameters is performed for each of the communication devices and the optical transmission paths because there is a difference in redundancy or critical path depending on the installation environment of each of the communication devices and the optical transmission paths.

Then, as illustrated in FIG. 5, the route setting unit 14 of the network management device 10 performs matching between a route policy based on the QoS set by the user and stored in the route policy storage unit 17, and the quality information output from the condition determination unit 13 (step S15). Specifically, the route setting unit 14 performs approximation on the quality information parameter of the route policy and the quality information parameter output from the condition determination unit 13, and sets a communication route based on the matched or approximated optical transmission path (step S16). Then, the network management device 10 uses the route information of the set communication route to set a route with respect to each communication device R disposed on the network system N.

In this manner, in the first example, when it is determined that icing W has occurred on an optical fiber that is a transmission path denoted by a reference sign F1, a communication route bypassing the optical fiber F1 is set, as illustrated in FIG. 6 for example. Therefore, a communication route indicated by a dotted line A in FIG. 6 is not set, and a communication route indicated by a solid line A2 is set. As a result, in the present invention, it is possible to set an appropriate communication route corresponding to the natural environment.

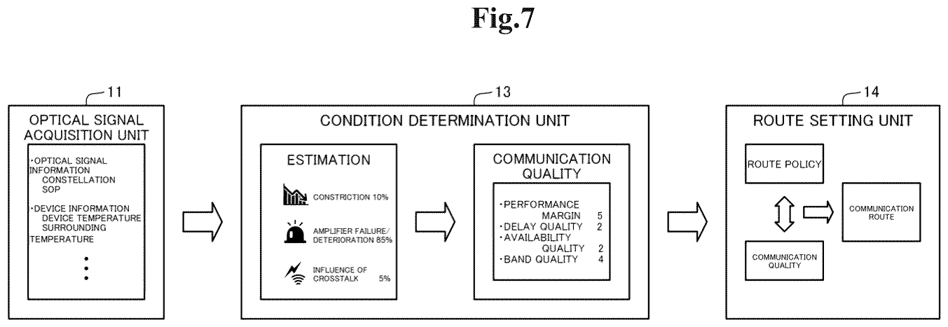

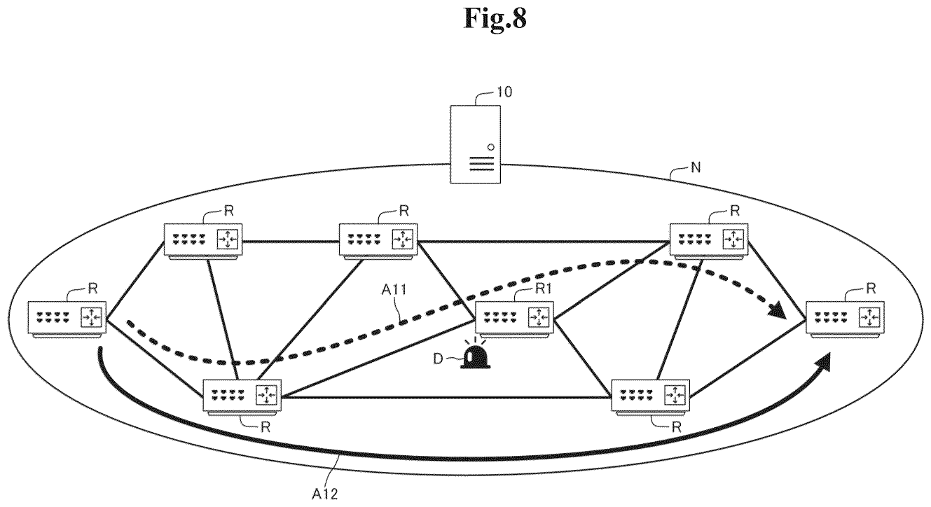

Next, a second example of an operation of the network management device 10 will be described with reference to the flowcharts of FIGS. 3 and 4, the operation outline diagram of FIG. 7, and the network diagram of FIG. 8. First, a model creation phase will be described with reference to FIG. 3.

First, in the model creation phase, the optical signal acquisition unit 11 of the network management device 10 acquires, from each of the communication devices R, an optical signal communicated by the communication device R, and acquires optical signal information such as a constellation and SOP from the optical signal (step S1). The optical signal acquisition unit 11 also acquires, from various types of sensors, device information including operating states such as loads on the optical transmission path and the communication device, temperature of the optical transmission path and the communication device, ambient temperature that is surrounding temperature, and the like (step S1). Then, the optical signal acquisition unit 11 stores the acquired information as learning data.

Further, the network management device 10 acquires the external environmental conditions such as weather or disaster at the location where the communication device and the optical transmission path are installed and the deterioration states of the communication device and the optical transmission path, as training data, and stores them (step S2). In particular, in the second example, deterioration states of the communication device R and the optical transmission path F are used as training data. Note that the training data is input by the administrator or the operator, or provided by another information processing device, whereby the data is acquired and stored therein by the network management device 10.

Thereafter, the learning unit 12 inputs the learning data and the training data into the machine learning device and performs learning (step S3), the learning unit 12 generates a determination model for estimating the physical condition of the optical transmission path from the optical signal information and the device information (step S4). However, this learning may be performed by another information processing device. Then, the generated determination model is stored in the determination model storage unit 16 of the network management device 10 (step S4). In this example, it is assumed that a model for estimating the deterioration states such as the number of years in use or failure states of the router that is the communication device R is generated, particularly.

Next, the route setting phase will be described with reference to FIGS. 4, 7, and 8. In the route setting phase, an operation to set a communication route of an optical signal is performed when data transmission is made in the network system. Therefore, the network management device 10 has accepted a QoS request from a client (end user or network administrator) related to the data transmission, and has stored the route policy corresponding to the QoS request in the route policy storage unit 17 in advance.

Then, at the time of performing data transmission, the optical signal acquisition unit 11 acquires an optical signal communicated by each of the communication devices R, and acquires optical signal information such as a constellation and SOP from the optical signal. Moreover, the optical signal acquisition unit 11 acquires, from various types of sensors, device information including operating states such as loads on the optical transmission path and the communication device, temperature of the optical transmission path and the communication device, ambient temperature that is surrounding temperature, and the like (step S11).

Then, the condition determination unit 13 reads out a determination model stored in the determination model storage unit 16, and inputs the newly acquired optical signal information and device information to the determination model (step S12) to thereby estimate the physical conditions of the communication device R and the optical transmission path F (step S13). In the second example, as illustrated in FIG. 7, deterioration states such as “constriction (filter constriction), amplifier failure/deterioration, influence of crosstalk” of the router that is the communication device R are estimated, and the probabilities of the respective deterioration states are also estimated. In particular, in the second example, it is determined that the deterioration state is “amplifier failure/deterioration” among “filter constriction, amplifier failure/deterioration, influence of crosstalk”, and the probabilities of all estimated conditions are estimated as “constriction 10%, amplifier failure/deterioration 85%, influence of crosstalk 5%”.

Then, on the basis of the condition and the probability estimated as described above and the acquired optical signal information, the condition determination unit 13 calculates quality information parameters of the communication quality of the transmission path (step S14). For example, as illustrated in FIG. 7, four parameters, namely, availability quality, band quality, delay quality, and performance margin, are calculated as parameters of quality information. At this time, by calculating the quality information parameters by using not only the estimated condition but also estimation probability, it is possible to reflect not only uniform quality information parameters linked to the amplifier failure/deterioration illustrated herein as an example, but also information of quality deterioration caused by an actual failure state on the quality information parameters.

Then, as illustrated in FIG. 7, the route setting unit 14 performs matching between a route policy based on the QoS set by the user and stored in the route policy storage unit 17, and the quality information output from the condition determination unit 13 (step S15). Specifically, the route setting unit 14 performs approximation on the quality information parameter of the route policy and the quality information parameter output from the condition determination unit 13, to thereby set a communication route based on the matched or approximated optical transmission path (step S16). Then, the network management device 10 uses the route information of the set communication route to set a route with respect to each communication device R disposed on the network system N.

In this manner, in the second example, when it is determined that failure/deterioration D is caused in the amplifier of the router that is a communication device denoted by a reference sign R1, a communication route bypassing the router R1 is set, as illustrated in FIG. 8 for example. Therefore, a communication route indicated by a dotted line A11 in FIG. 8 is not set, and a communication route indicated by a solid line A12 is set. As a result, in the present invention, it is possible to set an appropriate communication route corresponding to the deterioration state of the facility.

### Second Example Embodiment

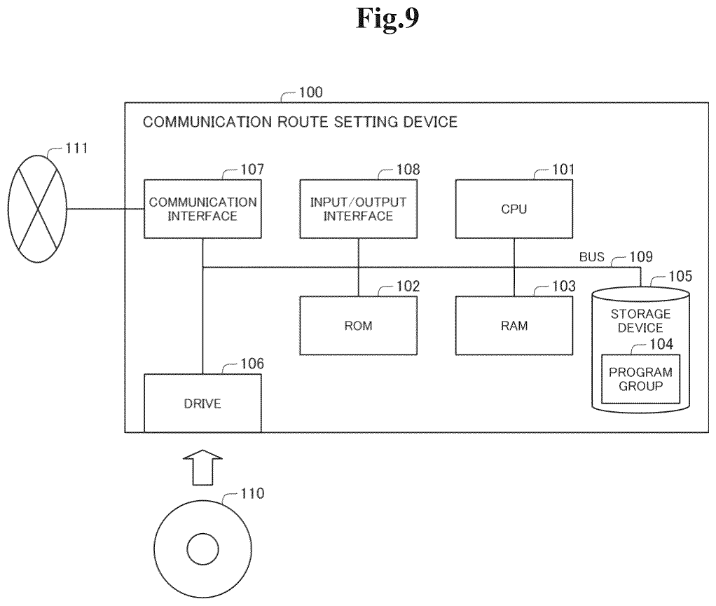

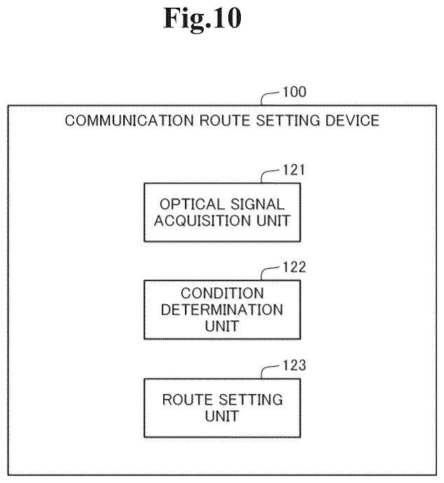

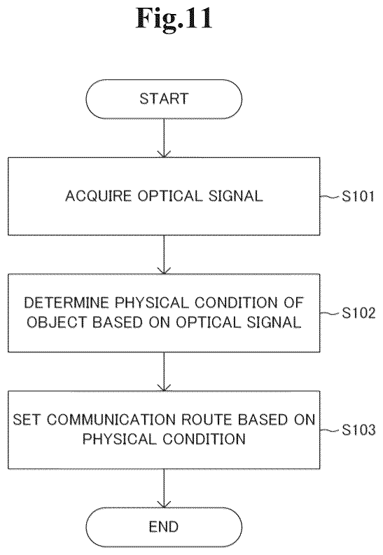

Next, a second example embodiment of the present invention will be described with reference to FIGS. 9 to 11. FIGS. 9 and 10 are block diagrams illustrating a configuration of a communication route setting device according to the second example embodiment, and FIG. 11 is a flowchart illustrating an operation of the communication route setting device. Note that the present embodiment shows the outlines of the configurations of the communication route setting device and the communication route setting method explained in the embodiment described above.

First, a hardware configuration of a communication route setting device 100 in the present embodiment will be described with reference to FIG. 9. The communication route setting device 100 is configured of a typical information processing device, having a hardware configuration as described below as an example.
Central Processing Unit (CPU) 101 (arithmetic device)
Read Only Memory (ROM) 102 (storage device)
Random Access Memory (RAM) 103 (storage device)
Program group 104 to be loaded to the RAM 103
Storage device 105 storing therein the program group 104
Drive 106 that performs reading and writing on a storage medium 110 outside the information processing device
Communication interface 107 connecting to a communication network 111 outside the information processing device
Input/output interface 108 for performing input/output of data
Bus 109 connecting the respective constituent elements

The communication route setting device 100 can construct, and can be equipped with, an optical signal acquisition unit 121, a condition determination unit 122, and a route setting unit 123 illustrated in FIG. 10 through acquisition and execution of the program group 104 by the CPU 101. Note that the program group 104 is stored in the storage device 105 or the ROM 102 in advance, and is loaded to the RAM 103 by the CPU 101 and executed by the CPU 101 as needed. Further, the program group 104 may be provided to the CPU 101 via the communication network 111, or may be stored on the storage medium 110 in advance and read out by the drive 106 and supplied to the CPU 101. However, the optical signal acquisition unit 121, the condition determination unit 122, and the route setting unit 123 may be constructed by dedicated electronic circuits for implementing such means.

Note that FIG. 9 illustrates an example of a hardware configuration of an information processing device that is the communication route setting device 100. The hardware configuration of the information processing device is not limited to that described above. For example, the information processing device may be configured of part of the configuration described above, such as without the drive 106.

The communication route setting device 100 executes the communication route setting method illustrated in the flowchart of FIG. 11, by the functions of the optical signal acquisition unit 121, the condition determination unit 122, and the route setting unit 123 constructed by the program as described above.

As illustrated in FIG. 11, the communication route setting device 100 performs processing to
acquire an optical signal on a transmission path in a network configured of optical communication devices connected with each other via an optical transmission path (step S101),
determine the physical condition of at least one object of the optical transmission path and the optical communication devices, on the basis of the optical signal (step S102), and
set a communication route for transmitting the optical signal on the network, on the basis of the determined physical condition (step S103).

With the configuration described above, the present invention can set an appropriate communication route corresponding to the physical condition such as an external environmental condition or a deterioration state of a facility such as an optical communication device and an optical transmission path.

Note that the program described above can be supplied to a computer by being stored in a non-transitory computer-readable medium of any type. Non-transitory computer-readable media include tangible storage media of various types. Examples of non-transitory computer-readable media include magnetic storage media (for example, flexible disk, magnetic tape, and hard disk drive), magneto-optical storage media (for example, magneto-optical disk), a CD-ROM (Read Only Memory), a CD-R, a CD-R/W, and semiconductor memories (for example, mask ROM, PROM (Programmable ROM), EPROM (Erasable PROM), flash ROM, and RAM (Random Access Memory)). The program may be supplied to a computer by a transitory computer-readable medium of any type. Examples of transitory computer-readable media include electric signals, optical signals, and electromagnetic waves. A transitory computer-readable medium can be supplied to a computer via a wired communication channel such as a wire and an optical fiber, or a wireless communication channel.

While the present invention has been described with reference to the example embodiments described above, the present invention is not limited to the above-described embodiments. The form and details of the present invention can be changed within the scope of the present invention in various manners that can be understood by those skilled in the art. Further, at least one of the functions of the optical signal acquisition unit 121, the condition determination unit 122, and the route setting unit 123 described above may be carried out by an information processing device provided and connected to any location on the network, that is, may be carried out by so-called cloud computing.

### Supplementary Notes

The whole or part of the example embodiments disclosed above can be described as the following supplementary notes. Hereinafter, outlines of the configurations of a communication route setting method, a communication route setting device, and a program, according to the present disclosure, will be described. However, the present invention is not limited to the configurations described below.

### Supplementary Note 1

A communication route setting method comprising:
acquiring an optical signal on a transmission path in a network in which optical communication devices are connected to each other via an optical transmission path;
determining a physical condition of at least one object of the optical transmission path and the optical communication devices, on a basis of the optical signal; and
setting a communication route for transmitting the optical signal on the network, on a basis of the determined physical condition.

### Supplementary Note 2

The communication route setting method according to supplementary note 1, further comprising
determining a deterioration state of the object as the physical condition.

### Supplementary Note 3

The communication route setting method according to supplementary note 1 or 2, further comprising
determining an external environmental condition of the object as the physical condition.

### Supplementary Note 4

The communication route setting method according to any of supplementary notes 1 to 3, further comprising:
acquiring optical signal information representing a characteristic of the optical signal; and
determining the physical condition of the object on a basis of the optical signal information.

### Supplementary Note 5

The communication route setting method according to supplementary note 4, further comprising
acquiring a constellation of the optical signals as the optical signal information.

### Supplementary Note 6

The communication route setting method according to supplementary note 4 or 5, further comprising
acquiring a state of polarization (SOP) of the optical signal as the optical signal information.

### Supplementary Note 7

The communication route setting method according to any of supplementary notes 1 to 6, further comprising:
generating a model representing a relationship between the optical signal acquired in advance and a physical condition of the object when the optical signal is acquired; and
determining the physical condition of the object on a basis of the model and a newly acquired optical signal.

### Supplementary Note 8

The communication route setting method according to any of supplementary notes 1 to 7, further comprising:
acquiring a predetermined measurement value measured by a measurement device provided to the object; and
determining the physical condition of the object on a basis of the optical signal and the measurement value.

### Supplementary Note 9

The communication route setting method according to any of supplementary notes 1 to 8, further comprising:
setting communication quality of the object on a basis of the determined physical condition of the object; and
setting the communication route on a basis of the set communication quality.

### Supplementary Note 10

The communication route setting method according to supplementary note 9, further comprising
setting the communication route that satisfies requested communication quality on a basis of the set communication quality.

### Supplementary Note 11

A communication route setting device comprising:
an optical signal acquisition unit that acquires an optical signal on a transmission path in a network in which optical communication devices are connected to each other via an optical transmission path;
a condition determination unit that determines a physical condition of at least one object of the optical transmission path and the optical communication devices, on a basis of the optical signal; and
a route setting unit that sets a communication route for transmitting the optical signal on the network, on a basis of the determined physical condition.

### Supplementary Note 12

The communication route setting device according to supplementary note 11, wherein
the condition determination unit determines a deterioration state of the object as the physical condition.

### Supplementary Note 13

The communication route setting device according to supplementary note 11 or 12, wherein
the condition determination unit determines an external environmental condition of the object as the physical condition.

### Supplementary Note 14

The communication route setting device according to any of supplementary notes 11 to 13, wherein
the optical signal acquisition unit acquires optical signal information representing a characteristic of the optical signal, and
the condition determination unit determines the physical condition of the object on a basis of the optical signal information.

### Supplementary Note 15

The communication route setting device according to supplementary note 14, wherein
the optical signal acquisition unit acquires a constellation of the optical signals as the optical signal information.

### Supplementary Note 16

The communication route setting device according to supplementary note 14 or 15, wherein
the optical signal acquisition unit acquires a state of polarization (SOP) of the optical signal as the optical signal information.

### Supplementary Note 17

The communication route setting device according to any of supplementary notes 11 to 16, further comprising
a model generation unit that generates a model representing a relationship between the optical signal acquired in advance and a physical condition of the object when the optical signal is acquired, wherein
the condition determination unit determines the physical condition of the object on a basis of the model and a newly acquired optical signal.

### Supplementary Note 18

The communication route setting device according to any of supplementary notes 11 to 17, wherein
the optical signal acquisition unit acquires a predetermined measurement value measured by a measurement device provided to the object, and
the condition determination unit determines the physical condition of the object on a basis of the optical signal and the measurement value.

### Supplementary Note 19

The communication route setting device according to any of supplementary notes 11 to 18, wherein
the condition determination unit sets communication quality of the object on a basis of the determined physical condition of the object, and
the route setting unit sets the communication route on a basis of the set communication quality.

### Supplementary Note 20

The communication route setting device according to supplementary note 19, wherein
the route setting unit sets the communication route that satisfies requested communication quality on a basis of the set communication quality.

### Supplementary Note 21

A computer-readable medium storing thereon a program for causing a computer to execute processing to:
acquire an optical signal on a transmission path in a network in which optical communication devices are connected to each other via an optical transmission path;
determine a physical condition of at least one object of the optical transmission path and the optical communication devices, on a basis of the optical signal; and
set a communication route for transmitting the optical signal on the network, on a basis of the determined physical condition.

### REFERENCE SIGNS LIST

10 network management device
11 optical signal acquisition unit
12 learning unit
13 condition determination unit
14 route setting unit
16 determination model storage unit
17 route policy storage unit
F optical transmission path
R communication device
100 communication route setting device
101 CPU
102 ROM
103 RAM
104 program group
105 storage device
106 drive
107 communication interface
108 input/output interface
109 bus
110 storage medium
111 communication network
121 optical signal acquisition unit
122 condition determination unit
123 route setting unit

What is claimed is:

1. A communication route setting method comprising:
acquiring an optical signal on a transmission path in a network in which optical communication devices are connected to each other via an optical transmission path;
determining a physical condition of at least one object of the optical transmission path and the optical communication devices, on a basis of the optical signal; and
setting a communication route for transmitting the optical signal on the network, on a basis of the determined physical condition.

2. The communication route setting method according to claim 1, further comprising
determining a deterioration state of the object as the physical condition.

3. The communication route setting method according to claim 1, further comprising
determining an external environmental condition of the object as the physical condition.

4. The communication route setting method according to claim 1, further comprising:
acquiring optical signal information representing a characteristic of the optical signal; and
determining the physical condition of the object on a basis of the optical signal information.

5. The communication route setting method according to claim 4, further comprising
acquiring a constellation of the optical signals as the optical signal information.

6. The communication route setting method according to claim 4, further comprising
acquiring a state of polarization (SOP) of the optical signal as the optical signal information.

7. The communication route setting method according to claim 1, further comprising:
generating a model representing a relationship between the optical signal acquired in advance and a physical condition of the object when the optical signal is acquired; and
determining the physical condition of the object on a basis of the model and a newly acquired optical signal.

8. The communication route setting method according to claim 1, further comprising:
acquiring a predetermined measurement value measured by a measurement device provided to the object; and
determining the physical condition of the object on a basis of the optical signal and the measurement value.

9. The communication route setting method according to claim 1, further comprising:
setting communication quality of the object on a basis of the determined physical condition of the object; and
setting the communication route on a basis of the set communication quality.

10. The communication route setting method according to claim 9, further comprising
setting the communication route that satisfies requested communication quality on a basis of the set communication quality.

11. A communication route setting device comprising:
at least one memory configured to store instructions; and
at least one processor configured to execute instructions to:
acquire an optical signal on a transmission path in a network in which optical communication devices are connected to each other via an optical transmission path;
determine a physical condition of at least one object of the optical transmission path and the optical communication devices, on a basis of the optical signal; and
set a communication route for transmitting the optical signal on the network, on a basis of the determined physical condition.

12. The communication route setting device according to claim 11, wherein the at least one processor is configured to execute the instructions to
determine a deterioration state of the object as the physical condition.

13. The communication route setting device according to claim 11, wherein the at least one processor is configured to execute the instructions to
determine an external environmental condition of the object as the physical condition.

14. The communication route setting device according to claim 11, wherein the at least one processor is configured to execute the instructions to:
acquire optical signal information representing a characteristic of the optical signal; and
determine the physical condition of the object on a basis of the optical signal information.

15. The communication route setting device according to claim 14, wherein the at least one processor is configured to execute the instructions to
acquire a constellation of the optical signals as the optical signal information.

16. The communication route setting device according to claim 14, wherein the at least one processor is configured to execute the instructions to
acquire a state of polarization (SOP) of the optical signal as the optical signal information.

17. The communication route setting device according to claim 11, wherein the at least one processor is configured to execute the instructions to:
generate a model representing a relationship between the optical signal acquired in advance and a physical condition of the object when the optical signal is acquired; and
determine the physical condition of the object on a basis of the model and a newly acquired optical signal.

18. The communication route setting device according to claim 11, wherein the at least one processor is configured to execute the instructions to:
acquire a predetermined measurement value measured by a measurement device provided to the object; and
determine the physical condition of the object on a basis of the optical signal and the measurement value.

19. The communication route setting device according to claim 11, wherein the at least one processor is configured to execute the instructions to:
set communication quality of the object on a basis of the determined physical condition of the object; and
set the communication route on a basis of the set communication quality.

20. (canceled)

21. A non-transitory computer-readable medium storing thereon a program comprising instructions for causing a computer to execute processing to:
acquire an optical signal on a transmission path in a network in which optical communication devices are connected to each other via an optical transmission path;
determine a physical condition of at least one object of the optical transmission path and the optical communication devices, on a basis of the optical signal; and
set a communication route for transmitting the optical signal on the network, on a basis of the determined physical condition.
